(19) United States
(12) Patent Application Publication
(10) Pub. No.: US 2020/0207638 A1
(43) Pub. Date: Jul. 2, 2020

(54) STAGED FILTRATION FEED SYSTEM

(71) Applicant: Metso Sweden AB, Trelleborg (SE)

(72) Inventors: Brian Knorr, Henrico, VA (US); Andrea Andersson, Sala (SE); Magnus Hedlund, Sala (SE)

(73) Assignee: Metso Sweden AB, Trelleborg (SE)

(21) Appl. No.: 16/234,839

(22) Filed: Dec. 28, 2018

(51) Int. Cl. C02F 1/00; B01D 25/12; B01D 25/00; B01D 36/04

(52) U.S. Cl. CPC C02F 1/004; B01D 25/12; B01D 25/005; B01D 25/007; B01D 25/004; B01D 36/04; C02F 2103/10; C02F 2209/03; C02F 2209/105; C02F 2209/11; C02F 2209/40; C02F 2209/44; C02F 2001/007; C02F 1/008

(57) ABSTRACT

The present invention relates to a method for treatment of a slurry comprising a liquid and particles suspended in the liquid. The method comprising the steps of providing a slurry to be treated; subjecting the slurry to a separating stage in which the particles of the slurry are divided into at least two subsets, a first subset being generally less difficult to dewater than a second subset; feeding a pressure filter with a flow of the first and second subsets, wherein in a first feeding step, a major part of the flow is defined by the first subset and in a subsequent second feeding step, a major part of the flow is defined by the second subset.

### FIELD OF THE INVENTION

The present invention relates to a filtration process of slurry, especially dewatering of tailings or dewatering of concentrate.

### BACKGROUND OF THE INVENTION

When extracting ore in a concentrator plant or during handling of tailings, it is common to use a pressure filter, sometimes also called filter press, to dewater a slurry containing particles to be extracted. The equipment operates under a displacement filtering principle and uses a series of filter plates which are arranged adjacent to one another and a closing pressure is exerted on the filter plates sealing them tightly together. Slurry such as mineral slurry is then introduced under pressure through an inlet to fill the individual spaces created between adjacent filter plates, the filter chambers, and a part of the liquid component, the filtrate is expelled. Filter membranes of the filter chambers may then be activated to compress the filter cakes. Then, compressed air or gas or liquid is introduced to drive out more liquid component by displacement, whereby the solid particulate matter is retained. The filtrate is led to an outlet where it is discharged and the solid particulate cake remaining in each individual space after the filter cycle is removed in preparation for a subsequent filter cycle. The pressure and amount of time required to finish each cycle will vary depending on among other things the properties of the slurry, and sometimes substantial time and pressure are required.

### SUMMARY OF THE INVENTION

An object of the invention is to overcome, or at least lessen the problems involved with prior art pressure filter solutions. A particular object is to provide a method for staged filtration. The method for treatment of a slurry comprising a liquid and particles suspended in said liquid, comprises the steps of providing a slurry to be treated. This could for example be a slurry produced in a previous step in a concentrator plant or a slurry from for example a tailings dam comprising byproducts from mining operations. The slurry will comprise a liquid phase (i.e. water) and a solid phase comprising particles. Thereafter, the slurry is subjected to a separating stage in which the particles of the slurry are divided into at least two subsets. A first subset being generally less difficult to dewater than a second subset. Then, a pressure filter is fed with a flow of said first and second subsets and in a first feeding step, a major part of the flow is defined by the first subset and in a subsequent second feeding step, a major part of the flow is defined by the second subset. The method in accordance with the present invention has the advantage that treatment time and/or required treatment pressure in the pressure filter chambers can be reduced. In prior art systems, the slurry is fed directly to the chambers of the pressure filter. The slurry typically comprises a mixture of particles being difficult to dewater and particles being less difficult to dewater. The former type of particles sometimes has a tendency of clogging of the filter media already at an early stage which will have the effect that higher pressures and longer treatment times are required to finish the treatment cycle. In accordance with the present invention on the other hand, the first subset is fed to the pressure filter first and only later in the cycle is the second subset fed to the pressure filter. Since the particles of the first subset often are less prone to clog the pressure filter, a high dewatering rate can be maintained over a longer time which allows for a higher feeding rate during an initial stage, thus reducing overall cycle time. Subsequently, a flow of slurry comprising the second subset of particles is fed to the chambers of the pressure filter. The particles of the second subset will therefore not necessarily reach the filter media but instead get stuck on the already present particles of the first subset and in any case it will take some time before particles of the second subset reach the filter media. Thus, clogging of the filter media can be delayed and the dewatering rate towards a pre-set goal can be kept at a higher level than with prior art solutions and also, end products comprising less liquid can be achieved. It should be noted that even though the filtration described above has been described as being performed in two entirely separated stages, i.e. only first subset first and only second subset in a second stage, it is possible and lies within the scope of the invention that the two subsets can be mixed such that a slurry having a first specific ratio of the first and second subsets is fed to the chambers of the pressure filter in a first stage and a slurry having a second specific ratio of the first and second subsets is fed to the chambers of the pressure filter in a second stage to optimize performance. It is also possible to vary the ratio of the at least two subsets continuously over time. As indicated elsewhere, it is also possible to provide more than two subsets in order to optimize the procedure.

In accordance with an embodiment of the method, in the first feeding step the flow is defined entirely by said first subset. By feeding the pressure filter in a first step with the first subset only, it can be achieved that a layer of particles being less difficult to dewater is built up on the surface of the filter media before any of the particles which are more difficult to dewater reaches the filter media. By the present invention, it can be achieved that layer after layer are built up on the filter media in a preferred order.

In accordance with an embodiment of the method, in the second feeding step the flow is defined entirely by said second subset. By means of this method, it is possible to use the first subset as an additional filtering element and avoid that the particles of the second subset block the filter media, or at least delay the clogging.

In accordance with an embodiment of the method, the second subset is subjected to a separation step prior to feeding to the pressure filter. By using a for example a thickener prior to the pressure filter, it is possible to separate some of the liquid from the slurry and obtain a thicker slurry, thus reducing the amount of liquid that the pressure filter has to handle. Examples of such separators are Inclined Plate Settlers (IPS) and Spiral Dewaterers but other methods or equipments are conceivable. Also, it is possible to use as many separation steps as preferred before the pressure filter such that the invention is not limited a single step.

In accordance with an embodiment of the method, a step of displacing liquid by introducing gas, such as air, through the particles is added. By blowing e.g. air through the particles it is possible to displace the water contained in the cake created by particles of the at least two subsets and thereby obtain a preferred water content in the final product in a fast manner.

In accordance with an embodiment of the method, the first and second subsets are defined by the size of the particles. Often, it is possible to use particle size as divider between difficult and less difficult to dewater. Typically, smaller particles are harder to dewater since they have a tendency to clog the filter media to larger degree than particles having a larger size and a higher pressure must be maintained to achieve a wanted dewatering rate.

In accordance with an embodiment of the method, the dividing line between the first and second subsets is in the range of 0.1-500 microns, specifically 10-100 microns, specifically 20-80 microns, more specifically 25-50 microns, wherein the particles of the first subset being of generally larger diameter than the dividing line and the particles of the second subset being of generally smaller diameter than the dividing line. These ranges have been found to comprise relevant dividing lines when it comes to particle size.

In accordance with an embodiment of the method, the first and second subsets are defined by the shape of the particles. Even though particle size can be used to define the first and second subsets, particle shape is also relevant when it comes to establish the ease with which a slurry may be dewatered. For example, particles having more or less regular shapes are typically less difficult to dewater than particles having more irregular shapes.

In accordance with an embodiment of the method, the particles of said first subset having a shape being generally more spherical than the particles of said second subset.

In accordance with an embodiment of the method, the slurry to be treated comprises tailings from mining installations or a slurry originating from a concentrator plant. These applications are particularly suited for the method in accordance with the present invention.

In accordance with a second aspect of the invention, a system for treatment of a slurry comprising a liquid and particles suspended in said liquid is disclosed. The system comprising a separator arranged to separate the particles of the slurry into at least two subsets, a first subset being generally less difficult to dewater than a second subset, and a feeding arrangement arranged to feed the at least two subsets to a pressure filter in a controlled manner such that a ratio of the at least two subsets reaching the pressure filter can be adjusted. The advantages and benefits of the system in accordance with the present invention correspond to those described with respect to the method above.

In accordance with an embodiment of the system, a thickener in the form of a sedimentation and/or dewatering system is arranged between the separator and the pressure filter. By using a thickener prior to the pressure filter, it is possible to reduce some of the liquid comprised in the slurry and obtain a thicker slurry, thus reducing the amount of liquid that the pressure filter has to handle. Examples of such thickener are Inclined Plate Settlers (IPS) and Spiral Dewaterers.

In accordance with an embodiment of the system, the sedimentation and/or dewatering system is arranged to be applied on the second subset. Since most of the liquid comprised in the slurry of the first subset can be handled with ease in the pressure filter, there is no immediate need for a thickener to be applied to the first subset. Regarding the second subset on the other hand, it is of interest to reduce the amount of liquid entering the pressure filter. Even though the present invention increases flow rate during the entire treatment cycle, the rate with which a slurry can be dewatered in a pressure filter will decrease to a certain amount towards the end of the cycle, i.e. when the respective chamber of the pressure filter becomes full. Therefore, it is still of interest to decrease the amount of water entering the pressure filter, especially the water contained in the slurry of the second subset.

In accordance with an embodiment of the system, a control system is arranged to control a flow of the at least two subsets.

In accordance with an embodiment of the system, the control system includes a computing component for controlling the treatment of the slurry.

In accordance with an embodiment of the system, the control system is configured to take into consideration one or more of the following parameters:

a. Particle size distribution;

b. Particle shape distribution;

c. Particle surface character;

d. Particle density;

e. Flow rate of slurry to be treated;

f. Flow rate of the at least two subsets

g. Weight of material present in pressure filter;

h. Pressurizing time in pressure filter;

i. Current pressure in pressure filter;

j. Pressure variation over time in pressure filter;

k. Pressure filter media properties;

l. Filter pressure air flow properties;

m. Desired properties of an end product;

n. Pressure variation over time of the slurry feed of the at least two subsets.

The control system can determine any of the above mentioned parameters and determine which parameters need to be adjusted in order to obtain the desired end product and/or optimal process properties. For example, the water content of the delivered end product, sometimes referred to as the cake, is often specified. Normally, but not necessarily always, the water content of the cake should be kept as low as possible. But to obtain lowest possible water content, treatment times and pressures would be disproportionately long and high, respectively.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

As used herein, the term “comprising” and variations of that term are not intended to exclude other additives, components, integers or steps.

### BRIEF DESCRIPTION OF THE DRAWINGS

The invention will be described in more detail and with reference to the appended drawings in which:

FIG. 1 shows a schematic block diagram of an embodiment of the system in accordance with the invention.

FIG. 2 shows a schematic cross-section through a treatment chamber of a pressure filter in accordance with an embodiment of the invention.

### DETAILED DESCRIPTION

The present invention will now be described more fully hereinafter with reference to the accompanying drawings, in which exemplifying embodiments of the invention are shown. The present invention may, however, be embodied in many different forms and should not be construed as limited to the embodiments set forth herein; rather, these embodiments are provided for thoroughness and completeness, and to fully convey the scope of the invention to the skilled addressee. Like reference characters refer to like elements throughout.

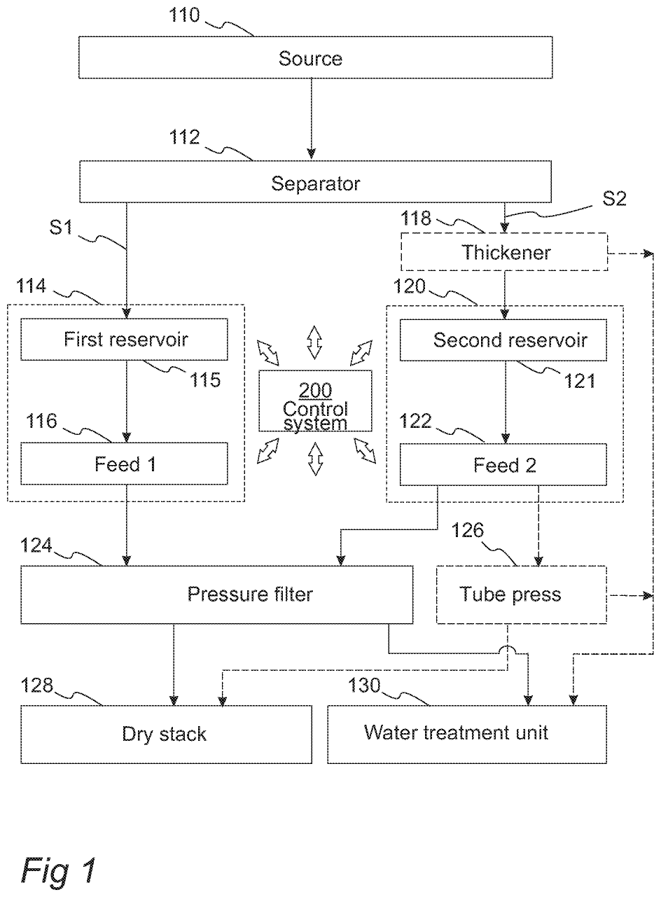

FIG. 1 shows a schematic block diagram describing an embodiment of the present invention. A source of slurry 110 comprising a liquid and particles, such as mineral particles, is provided, and can for example comprise a reservoir comprising slurry from a concentrator plant or from a tailings dam. In the mining industry it has been common to store tailings in the form of slurries contained in dams. However, so called dry-stacking of the tailings is more environmentally friendly but in order to be able to dry-stack the tailings it is necessary to dewater the slurry comprising the tailings. Furthermore, with rising commodity prices, it is sometimes interesting to extract e.g. ore still comprised in the tailings. The source 110 is thereafter fed to a separator 112, for example a desliming hydrocyclone, a screening device or a spiral separator, in which the slurry, and more particularly the particles of the slurry are separated into at least a first subsets S1 and a second subset S2. Often this is based on the size of the particles since smaller particles are generally more difficult to dewater in a pressure filter than larger particles. This since smaller particles tend to clog the filter media of the pressure filter, thus increasing the required treatment pressure and the required treatment time. As is described elsewhere in this application, other parameters may be used, alone or in combination, to define a dividing line between the subsets. For example, particle density can be used and a desliming hydrocyclone can be used to separate particles having different density from each other. It should be noted that even though two subsets are disclosed in this embodiment, three, four or even more subsets are possible within the scope of the invention. The first subset S1 is fed along a first treatment feeding line 114 typically comprising a first intermediate reservoir 115 for the slurry. A pump 116 or other slurry transporting arrangement is then used to feed the slurry to the pressure filter 124. The pressure filter 124 could for example be a vertical pressure filter but it is also conceivable to use other types, such as horizontal pressure filters. Similarly, the second subset S2 is fed along a second treatment feeding line 120 which typically comprises a second intermediate reservoir 121 and a pump 122 for feeding the slurry of the second subset to the pressure filter 124. In this embodiment, an optional thickening step is indicated after the separator 112 and prior to pressure filter 124 along the second treatment feeding line 120. This may be done to reduce water content of the slurry containing the particles that are more difficult to dewater to reduce the amount of liquid that the pressure filter has to handle. The thickener may for example comprise an Inclined Plate Settler (IPS), a screening arrangement or a spiral thickener. The slurry of the second subset S2 can thereafter be transported by means of pump 122 to the pressure filter 124 and it is also possible to transport a part of e.g. fine tailings to a tubular press 126. Such tubular press 126 is capable of handling particles which are very hard to dewater, for example very fine particles, but has a limited capacity in comparison with a pressure filter such as a vertical pressure filter and is best used to handle smaller amounts of particles. A plurality of tube presses can be arranged in parallel with each other to increase capacity. When treatment in pressure filter 124 and, where appropriate, in the tubular press 126, is finished, the particles, mostly in a compressed form of cakes is transported to a dry stack or other intermediate storing and the liquid may be recirculated into a plant process or may be subjected to purification or other treatment.

As can be seen in FIG. 1, a control system 200 is also provided. This control system 200 is configured to at least be capable of running the feeding to the pressure filter 124 and optionally the tubular press 126, separator 112 and all other equipment of the treatment such that the chambers of the pressure filter 124 is initially fed with a slurry where a major part thereof is slurry from the first subset S1. Subsequently, after for example a predetermined time or when a predetermined amount of slurry has been fed to the pressure filter 124, the control system 200 will feed the pressure filter 124 with a slurry where a major part thereof is slurry from the second subset S2. By first feeding the pressure filter 124 with particles that are less difficult to dewater it is possible to maintain a high flow rate through the pressure filter 124 during that feeding step. But the present invention also has the advantage that the flow through the pressure filter 124 can be maintained at a higher rate than in prior art solutions also during the subsequent feed of slurry containing the particles that are more difficult to dewater. This since these particles of the second subset S2 will adhere to the particles of the first subset S1 when in the chamber and not necessarily reach the filter media of the pressure filter, thereby avoiding, or at least reducing, clogging of the filter media. The particles of the first subset S1 will form a filtering bed having a certain depth on the surface of the filter media and at least some of the particles of the second subset will get stuck on or in this bed and thus never reach the filter media. With the present invention, the particles of the second subset are thereby spread out not only over the surface area of the filter media but also over the depth of the filtering bed created by the particles of the first subset S1, thereby eliminating, or at least reducing, the clogging effect of the particles of the second subset S2. In one embodiment, the subsets will be fed to the pressure filter in a separated manner. This means that in a first feeding step, only slurry comprising particles of the first subset S1 will be fed to the chambers of the pressure filter. Then, in a second feeding step only slurry comprising particles of the second subset S2 is fed to the chambers. In other embodiments, the pressure filter is fed by mixtures of the subsets S1, S2 and it is also possible to vary a ratio of the at least two subsets reaching the pressure filter over time. However, a first feeding step should comprise a slurry where the major part of the particles are from the first subset S1.

In accordance with the invention, the control system 200 may also comprise a computing component to help optimize the process. The system can be used for performing automatic and/or inferred action with respect to the present invention. That means, the system may receive information from for example plant personnel or from a plethora of sensors arranged throughout the system. The system may for example be configured to take into consideration one or more of the following parameters:

a. Particle size distribution in the slurry feed and the at least two subsets. This information can be provided by means of e.g. mathematical or manual particle size analyzers. Based on this type of information, the control system can decide where the dividing line between the at least two subsets S1, S2 shall be. It can also take this information into consideration when determining treatment pressures and treatment time in the chambers of the pressure filter

b. Particle shape distribution in the slurry feed and the at least two subsets. Similar to size, particle shape has a major impact on the dewatering properties of the particles. For example, particles having regular shapes such as spherical are generally easier to dewater than those with irregular shapes.

c. Particle surface character in the slurry feed and the at least two subsets.

d. Particle density in the slurry feed and the at least two subsets;

e. Flow rate of slurry to be treated;

f. Flow rate of the at least two subsets

g. Weight of material present in pressure filter. It is for example possible to use load cells measuring the weight of each chamber of the pressure filter, thereby keeping track in real time of the amount of particles present in the chamber. This information can be used to determine e.g. if additional slurry should be fed to the chamber or not.

h. Pressurizing time in pressure filter;

i. Current pressure in pressure filter;

j. Pressure variation over time in pressure filter;

k. Pressure filter filter media properties. An example of such properties is porosity.

l. Filter pressure air flow properties. By measuring pressure and flow rate of the gas, normally air, that is used to displace the water present in the particle cake in the chamber of the pressure filter, the control system can obtain information about the properties of the cake. For example permeability, water content etc.

m. Desired properties of an end product. If for example, a user is not interested in lowest possible water content of the end product, there is no need to go all the way in reducing water content and more focus can be made on process efficiency, keeping treatment time and costs down. In other cases, for example when the end product is to be transported long distances by truck, boat or similar, it is of great importance to reduce water content in order to avoid for example unnecessary transporting of water or that the water freezes during transportation. The increased treatment costs, for example higher pressure and longer treatment duration, in the filtration stage may then be more than compensated for, by reduced handling costs.

n. Pressure variation over time of the slurry feed of the at least two subsets.

The control system can determine any of the above mentioned parameters and can determine which parameters need to be adjusted in order to obtain the desired end product and/or optimal process properties. It should be noted that the control system 200 in one embodiment may control only the feeding of the two subsets S1, S2 based on pre-defined automatic actions. However, it may also control more or less the whole process from source 110 to water treatment 130 and it may do so by applying a combination of automated actions and inferred actions, based on input from all parts of the process.

It has been determined that by using the present invention, in certain applications filter filter medias having larger permeability can be used. Often, the first subset S1 will comprise particles having a generally larger size than those of the second subset S2. The larger particles will not be able to penetrate the openings of the filter media, even if these have been chosen to be larger than what is normally done in prior art solutions. When the particles of the second subset S2, being generally smaller than those of subset S1, is fed to the pressure filter, these will adhere to the particles of the first subset S1 in the chamber and thus not pass through the filter media. Being able to choose a filter media with larger openings is obviously of interest since flow rates will increase.

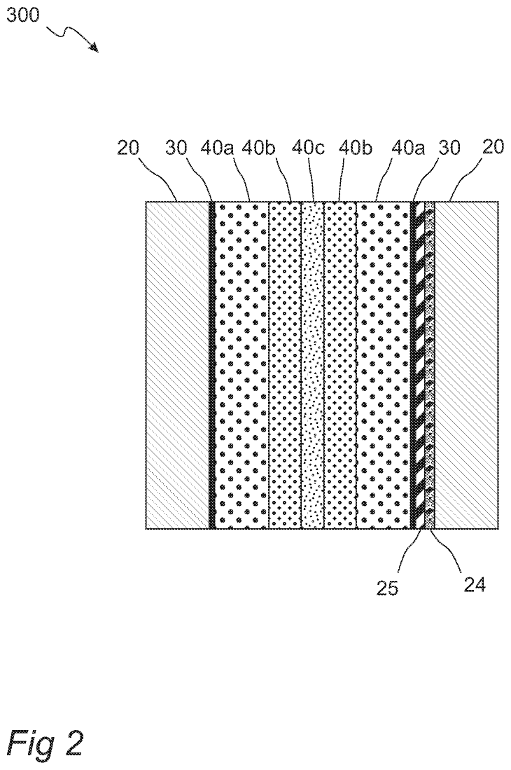

FIG. 2 shows a schematic cross-section through a chamber of a pressure filter on which the present invention has been applied. The outermost elements 20 are pressure filter plates. At 30, the filter filter medias are indicated. On the right hand side a membrane 25 and a pressurizing layer 24 of e.g. gas or water can be seen. On each of the filter medias 30, a layer 40a of particles being less difficult to dewater is created by first pumping a slurry comprising these particles into the chamber 300. On each of these layers 40a an additional particle layer 40b is created by pumping a slurry of particles being generally more difficult to dewater into the chamber 300. At 40c, a remaining flow of slurry comprising particles being generally more difficult to dewater can be seen. A separation of the layers 40a, 40b and 40c will take place since separation and dewatering will occur from the pump pressure used to fill the chambers. When the feed of slurry to the chamber has been stopped and a particle cake has been created, membrane 25 is pressurized by means of for example gas or water 24 and the cake is compressed at for example 15 bar. Other pressures such as 10-30 bar are known in the art and can be applied as required. This will cause further dewatering of the particles and water present in the chamber will be pressed through the filter media in this final stage of dewatering. This membrane pressurizing will also make sure that the cake of particles sticks together in one piece. And in accordance with the present invention, the filter media will be lessed clogged by particles and dewatering will be quicker and require less pressure. In a last step, air will be blown through the cake for example by means of nozzles not shown in the figures. The air will dry the cake by displacing most of the remaining water. Here, it is important that the cake of particles is kept together and that no cracks or similar is present. Should there be any cracks in the cake, the air will follow such that path and will not dewater the rest of the cake. If no cracks are present, the air will pass through the entire cake and dry out all or at least most of the water still present in the cake after the membrane pressurizing stage.

The skilled person realizes that a number of modifications of the embodiments described herein are possible without departing from the scope of the invention, which is defined in the appended claims. For example, the number of particle subsets can be chosen as found necessary and reasonable. Also, in the embodiment shown herein only the second subset is subjected to one step of dewatering, or thickening, prior to feeding to the pressure filter. The first subset may also be subjected to such treatment and more than one dewatering step may be done prior to feeding to the pressure filter. The present invention is also suitable with computing component having an artificial intelligence and/or machine learning component. The skilled professional understands that the present invention is also suitable to use with biomass, sludge and fibers as well.

We claim:

1. A method for treatment of a slurry comprising a liquid and particles suspended in said liquid, said method comprising the steps of:
providing at least two subsets of slurry to be treated, a first subset being generally less difficult to dewater than a second subset; and
feeding a pressure filter with a flow of said first and second subsets, wherein in a first feeding step, a major part of the flow is defined by said first subset and in a subsequent second feeding step, a major part of the flow is defined by said second subset.

2. The method in accordance with claim 1, wherein said method comprising the step of providing a slurry to be treated, subjecting the slurry to a separating stage in which the particles of the slurry are divided into said at least two subsets.

3. The method in accordance with claim 1, wherein in the first feeding step the flow is defined entirely by said first subset.

4. The method in accordance with claim 1, wherein in the second feeding step the flow is defined entirely by said second subset.

5. The method in accordance with claim 1, wherein said second subset is subjected to a thickening step prior to feeding to the pressure filter.

6. The method in accordance with claim 1, comprising a step of displacing liquid by introducing gas, such as air, through the particles.

7. The method in accordance with claim 1, wherein the first and second subsets are defined by the size of the particles.

8. The method in accordance with claim 7, wherein the particles in said first subset is generally smaller than 10-100 microns and the particles in said second subsets is generally larger than 10-100 microns.

9. The method in accordance with claim 1, wherein the first and second subsets are defined by the shape of the particles.

10. The method in accordance with claim 1, wherein the slurry to be treated comprises tailings from mining installations or a slurry originating from a concentrator plant.

11. A system for treatment of at least two subsets of slurry each comprising a liquid and particles suspended in said liquid, a first subset being generally less difficult to dewater than a second subset, said system comprising a feeding arrangement arranged to feed said at least two subsets to a pressure filter in a controlled manner such that a ratio of the at least two subsets reaching the pressure filter can be adjusted.

12. The system in accordance with claim 11, wherein the ratio of the at least two subsets reaching the pressure filter can be varied over time.

13. The system in accordance with claim 11, said system comprising a separator arranged to separate the particles of a slurry into said at least two subsets.

14. The system in accordance with claim 13, wherein a sedimentation and/or dewatering system is arranged between the separator and the pressure filter.

15. The system in accordance with claim 14, wherein the sedimentation and/or dewatering system is arranged to be applied on the second subset.

16. The system in accordance with claim 11, wherein a control system is arranged to control a flow of the at least two subsets.

17. The system in accordance with claim 16, wherein the control system is configured to control one or more of the pressure filter, a sedimentation system or dewatering system.

18. The system in accordance with claim 17, wherein the control system is configured to take into consideration one or more of the following parameters:
a. Particle size distribution in the slurry feed and the at least two subsets;
b. Particle shape distribution in the slurry feed and the at least two subsets;
c. Particle surface character in the slurry feed and the at least two subsets;
d. Particle density in the slurry feed and the at least two subsets;
e. Flow rate of slurry to be treated;
f. Flow rate of the at least two subsets
g. Weight of material present in pressure filter;
h. Pressurizing time in pressure filter;
i. Current pressure in pressure filter;
j. Pressure variation over time in pressure filter;
k. Pressure filter media properties;
l. Filter pressure air flow properties;
m. Desired water content in end product;
n. Pressure variation over time of the slurry feed of the at least two subsets.
